(19) United States
(12) Patent Application Publication
(10) Pub. No.: US 2019/0213596 A1
(43) Pub. Date: Jul. 11, 2019

(54) TOKENISATION PLATFORM AND COMPUTER-IMPLEMENTED METHOD FOR GENERATING A MODIFIED PAYMENT TOKEN FOR AN EXPRESS PAYMENT TRANSACTION

(71) Applicant: Mastercard International Incorporated, Purchase, NY (US)

(72) Inventor: Manu Dharmaiah Kallugudde, Bangalore (IN)

(21) Appl. No.: 16/237,170

(22) Filed: Dec. 31, 2018

(30) Foreign Application Priority Data
Jan. 9, 2018 (SG) 10201800215W

(51) Int. Cl. G06Q 20/40; G06Q 20/36; G06Q 20/32

(52) U.S. Cl. CPC G06Q 20/4018; G06Q 20/3278; G06Q 20/367

(57) ABSTRACT

A tokenisation platform for generating a modified payment token for an express payment transaction is described. The tokenisation platform comprises at least a computer processor and a data storage device, the data storage device comprising instructions operative by the processor to: receive, from a token requestor, a request for a modified payment token, the request comprising an account identifier; transmit an authorisation request to an issuer server associated with the account identifier, the authorisation request comprising a request for advanced authorisation or pre-authorisation of funds from an account associated with the account identifier; and to receive, from the issuer server, an authorisation response indicating whether the authorisation request was successful or declined. If the authorisation request is successful, the tokenisation platform will generate a modified payment token comprising tokenised account details associated with the account identifier and either advanced authorised funds or a pre-authorised fund value; and transmit, to the token requestor, the modified payment token for use in an express payment transaction.

### CROSS-REFERENCE TO RELATED APPLICATION

This application is a U.S. National Stage filing under 35 U.S.C. § 119, based on and claiming benefits of and priority to Singapore Patent Application No. 10201800215W filed on Jan. 9, 2018. The entire disclosure of the above application is incorporated herein by reference for all purposes.

### FIELD OF THE INVENTION

The present invention relates to a tokenisation platform and computer-implemented method for generating a modified payment token for an express payment transaction.

### BACKGROUND OF THE INVENTION

Digital payments are becoming more and more prevalent and plastic payment cards (which carry very limited static information) are moving into consumer mobile phones and other devices such as wearables, keys etc. with the help of technologies such as tokenisation, card-on-file transactions, near-field communication NFC (e.g. Tap & Pay) and electronic wallets. The move to digital payments provides an improved user experience for both customers and merchants.

At present, there are various ways to digitise payment cards and perform secure payments. However, tokenisation takes first position when it comes to secure payments and satisfying customer experience. Tokenisation allows a consumer to digitally encrypt his/her existing payment card data and incorporate it into a mobile electronic device for use at merchant terminals, such that his/her experience at a merchant terminal is essentially the same as for existing swipe or chip-based payment card transactions. In each of these cases, it takes around 25-40 seconds on average to complete a payment transaction. For a normal in-store payment, 25-40 seconds may be manageable although it can result in long queues during busy times and an unsatisfactory customer experience. However, when it comes to transit situations such as in train/metro stations, tolls, bus/tram tickets etc., such a waiting time is not acceptable. By contrast, an expected time to complete a payment in these scenarios would range from around 0.5-2 seconds. There is therefore a need to reduce payment transaction time at a merchant terminal, particularly for transit situations, in order to enable a more efficient and more convenient method of payment.

As a result of the long waiting time associated with authorising payment card-based transactions (whether digitised or not), customers tend to depend on stored-value cards or wallets where money is pre-loaded for faster use in transit situations. However, such stored-value cards and wallets are closed-loop solutions, meaning that the customer needs to have multiple stored-value cards or wallets to use with each different merchant or transit system.

It is therefore an aim of the present invention to provide a system and method for overcoming the above shortfalls.

### SUMMARY OF THE INVENTION

In general terms, the present disclosure proposes a tokenisation platform and computer-implemented method for generating a modified payment token for an express payment transaction.

In a first aspect of the present invention, there is provided a tokenisation platform for generating a modified payment token for an express payment transaction. The tokenisation platform comprises at least a computer processor and a data storage device, the data storage device comprising instructions operative by the processor to:

receive, from a token requestor, a request for a modified payment token, the request comprising an account identifier;
transmit an authorisation request to an issuer server associated with the account identifier, the authorisation request comprising a request for advanced authorisation or pre-authorisation of funds from an account associated with the account identifier;
receive, from the issuer server, an authorisation response indicating whether the authorisation request was successful or declined;
if the authorisation request is successful;
generate a modified payment token comprising tokenised account details associated with the account identifier and either advanced authorised funds or a pre-authorised fund value; and
transmit, to the token requestor, the modified payment token for use in an express payment transaction.

Thus, embodiments of the invention provide a tokenisation platform for generating a modified payment token that is both secure and suitable for express payments. This is because it contains either advanced authorised funds (i.e. whereby the issuer server has actually authorised (in advance) a payment and transferred the funds from the account to a holding account); or a pre-authorised fund value (i.e. whereby the issuer server has reserved the fund value in the account but has not actually debited the funds from the account). In both cases, the modified payment token may be used to pay for goods/services from a merchant, without requiring a merchant terminal to communicate via an acquirer server and payment network to seek authorisation from the issuer server in real-time since the funds have either already been authorised or pre-authorised. Thus, the merchant terminal only needs to perform a local check to determine whether the modified payment token is acceptable (e.g. whether it has not expired, whether it contains all required data and whether the amount of authorised or pre-authorised funds is sufficient) before accepting the payment. This process at the merchant terminal may be completed very quickly (e.g. in less than 1 or 2 seconds), thereby facilitating express payments with no discernible waiting time, which may be suitable for transit systems (i.e. train/metro stations, tolls, bus/tram fares, parking charges etc.) and other situations where faster payments are desirable, including in-store payments.

Conveniently, the modified payment token may be used via a customer electronic device such as a mobile phone, for example, through a near-field communication NFC Tap & Pay process (or via an electronic wallet or payment application) to expedite a payment transaction and improve customer experience. Effectively, embodiments of the invention allow merchants to authorise transactions directly, without any hesitation, and without requiring any external communication.

With current, closed-loop systems, payments are limited to a specific merchant or transit system and the customer is required to transfer funds into a wallet before they can be used. However, with embodiments of the present invention, payments can be made to any merchants or transit systems that accept tokenised payments in the same manner as they would for a normal card swipe or chip transaction.

In terms of security, as the account details and either advanced authorised funds or pre-authorised fund values are included in the modified payment token, only encrypted account details are passed to the merchant thereby keeping the account details secure and preventing misuse of the card number and other details.

As the advanced authorised funds and pre-authorised funds are obtained before the express payment transaction is made, the issuer institution effectively guarantees to the merchants that the funds are available and therefore the merchants themselves have no liability and can proceed with the transaction without hesitation, safe in the knowledge that the funds will be paid during a normal clearing and settlement procedure later. This is unlike the case for delayed authorisation of funds (where the usual authorisation process occurs after the transaction has taken place) and whereby the merchants themselves would be liable if the funds were not available.

The token requester may be constituted by an application executed on a customer electronic device (e.g. a mobile banking application, bank wallet application, or third-party wallet application) and configured to communicate via a payment gateway server, a merchant terminal or an issuer server.

The account identifier may be a card number, primary account number (PAN), account name, mobile phone number, customer identification (ID) etc. Furthermore, the account associated with the account identifier may be a payment card account (e.g. a debit or credit card account) or any other funding source.

The account details may comprise one or more of: a card number, a primary account number (PAN), an account name, an expiry date and a card verification value (CVV).

In some embodiments, the tokenisation platform may be a server and may be comprised in a computer system such as that constituting the Mastercard® Digital Enablement Service (MDES).

The request may further comprise one or more of the following parameters: a maximum value for each express payment transaction (i.e. a transaction limit); a maximum number of express payment transactions permitted in a predefined period (i.e. a transaction number limit); a maximum value of express payment transactions permitted in a predefined period (i.e. an accumulative value limit); and a maximum number of express payment transactions permitted using a single modified payment token (i.e. a token use limit).

The predefined period may be, for example, an hour, a day, a week, a month or a year.

The request for advanced authorisation or pre-authorisation of funds may also comprise one or more of the above parameters.

Based on the above parameters, a suitable amount is blocked from the account during each predefined period. In some embodiments, the amount may be referred to as a daily limit, however, it should be understood that the daily limit is not necessarily limited to an amount required for a single day and it could be based on another time period. In any case, the daily limit is effectively blocked from the account (and in the case of advanced authorised funds, placed into a holding account) until the end of the period (e.g. until the end of the day).

In some embodiments, the above parameters may be provided from the customer directly to the issuer server. In other embodiments, the issuer institution may determine some or all of the parameters. Accordingly, either the customer (directly or via a token requestor, i.e. application) or an issuer institution associated with the issuer server may set, for example, a daily limit for express payment transactions. In some embodiments, the customer or issuer institution may establish a maximum value for a single (i.e. one-off) express payment transaction using the modified payment token.

If the issuer server determines that the parameters are acceptable (e.g. based on knowledge of the account associated with the account identifier) it may confirm the same to the tokenisation platform, which may, in turn, confirm the same to the token requester.

Once the number of express payment transactions permitted using a single modified payment token (i.e. the token use limit) is reached, the customer may be asked (e.g. via the token requester) to request a new modified payment token in order to replenish the advanced authorised funds or pre-authorised fund value by transferring or reserving more funds from the account.

In a second aspect of the present invention, there is described a merchant terminal for processing an express payment transaction. The merchant terminal comprises at least a computer processor and a data storage device, the data storage device comprising instructions operative by the processor to:

receive, from a customer electronic device, a modified payment token comprising tokenised account details and either advanced authorised funds or a pre-authorised fund value;
verify the modified payment token; and
approve the express payment transaction if the modified payment token is verified.

Notably, the verification of the modified payment token is performed locally at the merchant terminal without requiring any remote authorisation or communication, thereby expediting the time to complete the express payment transaction (which may take 0.5-1 seconds). Once the express payment transaction is approved by the merchant terminal, the customer may receive his/her goods/services without further delay.

The customer electronic device may be a mobile device running an application (e.g. a mobile banking application, a bank wallet application, or a third-party wallet application) using near-filed communication NFC technology (e.g. Tap & Pay) to initiate the express payment transaction.

The step of verifying the modified payment token may comprise checking whether one or more of the following conditions are satisfied: i) the modified payment token has not expired; ii) the modified payment token contains all required data; iii) the advanced authorised funds or pre-authorised fund value is sufficient for the express payment transaction.

The merchant terminal may also determine whether the advanced authorised funds or pre-authorised fund value is less than or equal to a predetermined limit for express payment transactions.

If the merchant terminal determines that a condition is not met and the modified payment token is not verified, the express payment transaction is refused.

The data storage device may comprise further instructions operative by the processor to place the pre-authorised fund value into an authorisation file for actual authorisation of the funds (i.e. deduction from the account) at a predefined time (e.g. at an end of a day). In this case, a normal (delayed) authorisation process may be carried out via an acquirer server, payment network and issuer server. However, no such authorisation step is required for the advanced authorised funds.

The data storage device may comprise further instructions operative by the processor to place the advanced authorised funds (or pre-authorised fund value once authorised) into a clearing file for clearing and settlement at predefined time (e.g. at an end of a day). Thus, as normal, after the transaction is complete, the funds will later be transferred from the holding account to the merchant account.

If there are funds remaining in the modified payment token at the end of a predefined period (e.g. each day), the customer may choose to refund the remaining funds back to his/her account or to re-allocate them into a modified payment token for the next period (i.e. the next day). In this case, the customer may instruct the customer electronic device (e.g. via an application) to communicate with the issuer server (optionally via a token requester and/or tokenisation platform) to refund or re-allocate the remaining funds at the end of the period.

In some embodiments, if the advanced authorised funds or pre-authorised fund value is greater than a transaction value, the merchant terminal may receive a full amount of the advanced authorised funds or pre-authorised fund value and may subsequently refund the customer with an amount equal to the overpayment.

In some embodiments, the merchant terminal may deduct only a transaction value from the advanced authorised funds or pre-authorised fund value, leaving the remaining funds in the modified payment token for later use. This can be achieved, for example, through notification services provided by the tokenisation platform. The merchant terminal may send an authorisation request with a new identifier to identify this type of transaction and the tokenisation platform may trigger a notification service to both the issuer server and the customer electronic device so that the issuer server knows the transaction value spent at the merchant terminal and the value of the advanced authorised funds or pre-authorised fund value in the modified payment token can be updated accordingly.

In a third aspect of the present invention, there is described a computer-implemented method for generating a modified payment token for an express payment transaction. The method comprises:

receiving, from a token requestor, a request for a modified payment token, the request comprising an account identifier;
transmitting an authorisation request to an issuer server associated with the account identifier, the authorisation request comprising a request for either advanced authorisation or pre-authorisation of funds from an account associated with the account identifier;
receiving, from the issuer server, an authorisation response indicating whether the authorisation request was successful or declined;
if the authorisation request is successful;
generating a modified payment token comprising tokenised account details associated with the account identifier and either advanced authorised funds or a pre-authorised fund value; and
transmitting, to the token requestor, the modified payment token for use in an express payment transaction.

In a fourth aspect of the present invention, there is described a computer-implemented method for processing an express payment transaction. The method comprises:

receiving, from a customer electronic device, a modified payment token comprising tokenised account details and either advanced authorised funds or a pre-authorised fund value;
verifying the modified payment token; and
approving the payment transaction if the modified payment token is verified.

In some embodiments, the pre-authorised fund value may be configured to expire if unused within a predefined time period (e.g. 1 day or 1 week). In which case, the reserved funds will be released back into the account.

In a fifth aspect of the present invention, there is provided a non-transitory computer-readable medium having stored thereon program instructions for causing at least one processor to perform the method according to the third or fourth aspects of the invention.

Thus, the tokenisation platform, merchant terminal and computer-implemented methods provide improved convenience and security for express payment transactions that can be completed in less than 1 or 2 seconds thereby making them suitable for use in transit situations. The modified payment token may be considered as a value-associated token configured for quick payment transactions.

Other desirable features and characteristics will become apparent from the subsequent detailed description and the appended claims, taken in conjunction with the accompanying drawings of the disclosure. Moreover, within the scope of this proposed disclosure it is expressly intended that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

Non-limiting embodiments of the invention will now be described for the sake of example only, with reference to the following drawings in which:

FIG. 1A shows a conventional tokenisation process flow;

FIG. 1B shows a conventional payment process using a conventional token;

FIG. 2 shows a computer system for generating a modified payment token for an express payment transaction, in accordance with an embodiment of the invention;

FIG. 3 shows a tokenisation process flow in accordance with an embodiment of the invention;

FIG. 4 illustrates a method for generating a modified payment token for an express payment transaction, in accordance with an embodiment of the invention;

FIG. 5 shows a payment system using a modified payment token for an express payment transaction, in accordance with an embodiment of the invention;

FIG. 6 shows a payment process flow in accordance with an embodiment of the invention;

FIG. 7 illustrates a method for processing an express payment transaction, in accordance with an embodiment of the invention;

FIG. 8 shows a delayed payment authorisation flow in accordance with some embodiments of the invention;

FIG. 9 shows schematically the structure of a server which may be used in the computer system of FIG. 2 or the payment system of FIG. 5, in accordance with embodiments of the invention; and

FIG. 10 shows schematically the structure of a customer electronic device which may be used in the computer system of FIG. 2 or the payment system of FIG. 5, in accordance with embodiments of the invention.

### DETAILED DESCRIPTION OF THE EMBODIMENT

As used herein, the term “account” refers to any form of arrangement that a customer has with an institution that allows the customer to deposit and/or withdraw funds. An account can be a deposit account, a credit card account, a debit card account, a current account, a saving account, an overdraft account, an electronic wallet account or any other type of account offered by the institution. Furthermore, the account may be a loan account, in which case the customer owes money to the institution. In some embodiments, an account may be associated with a payment card, such as a credit card, a debit card, a prepaid card, a charge card, a membership card, a promotional card, a frequent flyer card, an identification card, a gift card, and/or any other device that may hold account information, such as mobile phones, smartphones, tablets, personal digital assistants (PDAs), key fobs, transponder devices, near-field communication (NFC) enabled devices, and/or computers.

The term “institution” is not necessarily limited to organizations which are legally constituted as banks, since in some jurisdictions other organizations may be permitted to maintain accounts. For example, an institution associated with an acquirer or an issuer can be one of the following: a bank, a financial technology company, or a financial institution.

The terms “component,” “module,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Moreover, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

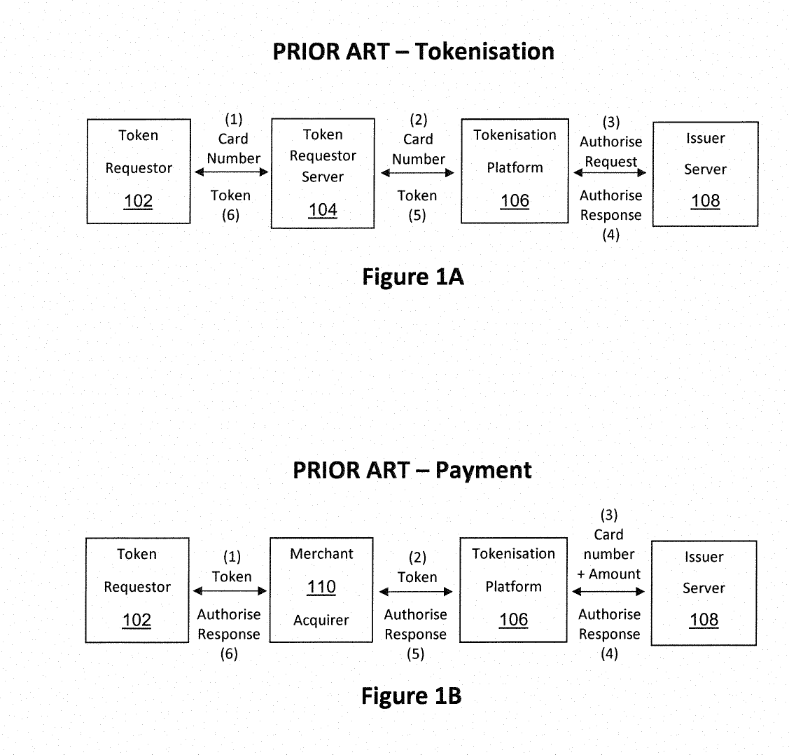

FIG. 1A shows a conventional tokenisation process flow wherein, in a first step (1) a token requester 102 (which may be in the form of a payment application running on a customer electronic device such as a mobile phone) transmits a request for tokenisation of a payment card including the card number to a token requestor server 104. The token requestor server 104 may be a server operationally connected to the application such as an issuer server or wallet server. The token requestor server 104 then transmits the card number to a tokenisation platform 106 for tokenisation, in a step (2). The tokenisation platform may be a server operated by a payment network provider. The tokenisation platform 106 transmits an authorisation request to an issuer server 108 associated with the card number, in a step (3). In this case, the authorisation request is a request to authorise the request for tokenisation from a card owner associated with the card number. The issuer server 108 may communicate directly with the card owner to authorise the request. For example, the issuer server 108 may transmit a dynamic one-time password to the card owner's registered mobile phone number and, if the same one-time password is correctly entered by the card owner into a suitable application in communication with the issuer server, the issuer server may authorise the request for tokenisation in a step (4). The tokenisation platform 106 will then generate a payment token mapped to the card number and will transmit the token to the token requestor server 104 in an encrypted format in a step (5). The token requestor server 104 will then transmit the token to the token requestor 102 in a step (6). The token requestor 102 may then store the token on the customer electronic device for future use.

FIG. 1B shows a conventional payment process using a conventional token such as that obtained through the tokenisation process of FIG. 1A. Thus, the token requestor transmits the token to a merchant server 110 for a payment transaction, in a first step (1). This may be done via a near field communication (NFC) Tap & Pay application executing on the customer electronic device and which is configured to wirelessly transmit the token to a merchant terminal. The merchant terminal in turn transmits the token to the merchant server 110, which, in turn transmits the token to an acquirer server. In a step (2) the acquirer server transmits the token to a payment network server which includes the tokenisation platform 106. The tokenisation platform 106 decrypts the token back into the card number and transmits the card number along with the transaction amount (which is also relayed with the token from the merchant server 110) to the issuer server 108, in a step (3). The issuer server 108 verifies the card number and amount and authorises the transaction if there are sufficient funds in an account associated with the card number. In a step (4), the issuer server 108 transmits an authorisation response to the tokenisation platform 106 to confirm whether the transaction is approved or denied. The tokenisation platform 106 transmits the authorisation response to the acquirer server and merchant server 110 in a step (5) and, in turn, the merchant server 110 transmits the authorisation response to the token requestor 102 in a step (6). Once the authorisation response is received by the token requestor (i.e. customer electronic device), the transaction may be completed and the customer may receive his/her purchased goods or services. However, it will be understood that the above payment process can take a certain amount of time. For example, in some situations, a transaction can take an average of 25-40 seconds to complete. Accordingly, such a payment process can create delays when used in transit situations such as on buses, trams, trains, tolls and parking as long queues of customers would arise and waiting time would be unacceptable resulting in a poor customer experience. Embodiments of the present invention aim to address this problem by providing a modified payment token for use in express payment transactions.

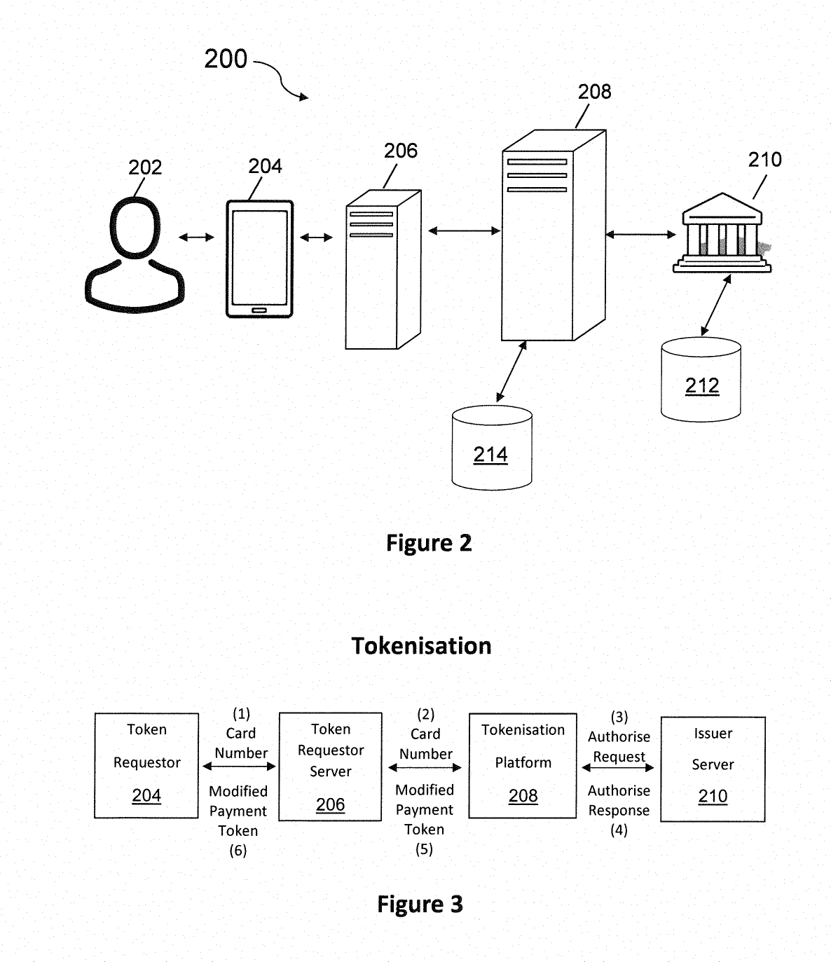

FIG. 2 shows a computer system 200 for generating a modified payment token for an express payment transaction, in accordance with an embodiment of the invention. The computer system 200 comprises a customer 202 having a customer electronic device 204 in the form of a smartphone (although other devices like laptops, tablets, computers, key-fobs etc. are also contemplated) which executes an application (e.g. a mobile banking application, bank wallet application, or third-party wallet application) and functions as a token requestor. The customer electronic device 204 is communicatively connected to a token requestor server 206 which may be constituted by a wallet server, issuer bank server or payment network server. The token requestor server 206 is communicatively connected to a tokenisation platform 208 which comprises a token database 214. The tokenisation platform 208 is communicatively connected to an issuer server 210 which comprises an account database 212.

Although only one customer 202, one customer electronic device 204, one token requestor server 206 and one issuer server 210 is shown in FIG. 2, it should be understood that, in practice, many of each of these components would form part of the computer system 200 and all of which would be operationally connected to at least one tokenisation platform 208.

As illustrated in FIG. 3, the customer electronic device 204 functions as the token requestor 204 and transmits a request for a modified payment token (comprising an account identifier in the form of a card number to be tokenised) to the token requestor server 206 in a step (1). The request (and card number) is then transmitted by the token requestor server 206 to the tokenisation platform 208 in a step (2). In other embodiments, the account identifier may be a primary account number (PAN), an account name, a mobile phone number or a customer identification (ID) etc. Furthermore, an account associated with the account identifier may be a payment card account (e.g. a debit or credit card account) or any other funding source.

The tokenisation platform 208 may form part of a payment network server and, in some embodiments may be comprised in the Mastercard® Digital Enablement Service (MDES) or other similar systems. Such a tokenisation platform 208 may enable a secure way of handling payment account information over various payment channels. In particular, the tokenisation platform 208 may facilitate secure near-field communication (NFC) payment systems such as Tap & Pay whereby a customer 202 simply taps his/her customer electronic device 204 (e.g. smartphone) on a merchant terminal (described below) to complete a secure payment using a stored token. Notably, the tokenisation platform 208 may enforce a number of different security measures to protect and limit the usage of tokens. These may comprise the use of single use keys which limit the number of transactions a token can be used for; tokens which are tied to a particular device (i.e. smartphone) such that if the token is stolen it cannot be used to make a payment from another device; and two-factor authentication (2FA) whereby the first factor authentication is by the device itself and the second factor authentication is by the customer 202 who is required to enter a fingerprint or personal identification number (PIN) to perform a payment using the token stored in the customer electronic device 204.

In a step (3), the tokenisation platform 208 is configured to transmit an authorisation request to the issuer server 210 associated with the card number. The authorisation request comprises a request for advanced authorisation or pre-authorisation of funds from an account associated with the card number.

The issuer server 210 processes the authorisation request. If the request is for advanced authorisation of funds, funds are actually authorised meaning that they are deducted from the account and placed into a holding account at the issuer server 210. However, if the request is for pre-authorisation of funds, the funds are reserved in the account but not actually deducted from the account. This is similar to a pre-authorisation of a payment card which is often performed by a hotel to cover hotel expenses during a stay. The pre-authorised funds may be set to expire (such that the funds are un-reserved) within a predefined period (e.g. 1 day or 1 week) if unused. Notably, for the case of pre-authorisation of funds, a delayed authorisation process (to deduct the funds from the account) is still required as will be explained in more detail below. In both cases, a subsequent clearing process is required to transfer the funds from the holding account at the issuer server 210 to an account associated with the merchant server.

An amount of advanced authorisation of funds or pre-authorisation of funds to be included in the modified payment token may be determined in a variety of ways. In some embodiments, the token requestor 202 may include the amount in the request for the modified payment token. In other embodiments, the amount may be set by the customer directly with the issuer server 210 or may be set by the issuer server 210 itself on an analysis of the account concerned.

The amount may be based on one or more of the following parameters: a maximum value for each express payment transaction (i.e. a transaction limit); a maximum number of express payment transactions permitted in a predefined period (i.e. a transaction number limit); a maximum value of express payment transactions permitted in a predefined period (i.e. an accumulative value limit); and a maximum number of express payment transactions permitted using a single modified payment token (i.e. a token use limit). The predefined period may be, for example, an hour, a day, a week, a month or a year. Thus, each and every transaction may be performed with the advanced authorised funds or pre-authorised funds included in the modified payment token, as described in more detail below.

Based on the above parameters, a suitable amount is blocked from the account during each predefined period. In some embodiments, the amount may be referred to as a daily limit, however, it should be understood that the daily limit is not necessarily limited to an amount required for a single day and it could be based on another time period. In any case, the daily limit is effectively blocked from the account (and in the case of advanced authorised funds, placed into a holding account) until the end of the period (e.g. until the end of the day).

In some embodiments, the customer or issuer institution may establish a maximum value for a single (i.e. one-off) express payment transaction using the modified payment token.

If the issuer server 210 determines that the parameters are acceptable (e.g. based on knowledge of the account associated with the account identifier) it may confirm the same to the tokenisation platform 208, which may, in turn, confirm the same to the token requestor 202. The parameters may also be stored in the account database 212.

In a step (4) shown in FIG. 3, the issuer server 210 sends an authorisation response to the tokenisation platform 208, the authorisation response indicating whether the authorisation request was successful or declined.

If the authorisation request is successful, the tokenisation platform 208 generates a modified payment token comprising tokenised account details associated with the account identifier and either advanced authorised funds or a pre-authorised fund value as per the request. The account details may comprise one or more of: a card number, a primary account number (PAN), an account name, an expiry date and a card verification value (CVV). The content of the modified payment token may be stored in the token database 214.

The modified payment token is then transmitted to the token requestor server 206 in a step (5) and then subsequently transmitted to the token requestor 204 in a step (6). Accordingly, the token requestor 204 (i.e. customer electronic device) receives the modified payment token for express payment transactions, which comprises a token number and one or more of: a transaction limit, a transaction number limit, an accumulative value limit and a token use limit associated with the advanced authorised funds or pre-authorised funds.

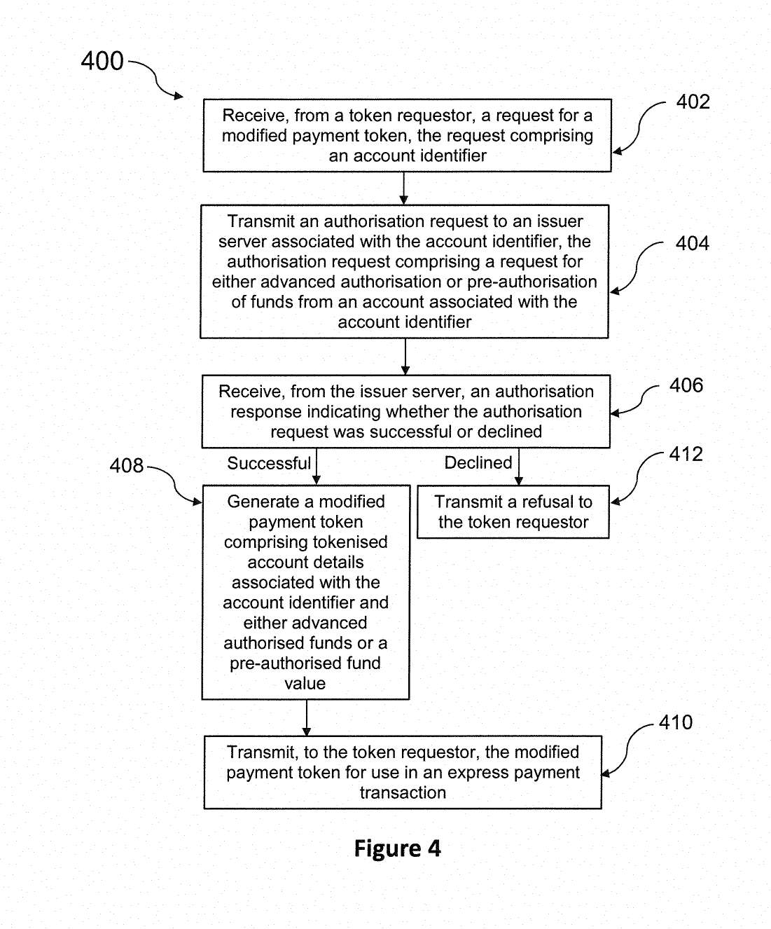

FIG. 4 illustrates the main steps of a computer-implemented method 400 for generating a modified payment token for an express payment transaction, as carried out by a processor of the tokenisation platform 208 operating instructions stored on data storage device. The method comprises: a step 402 of receiving, from a token requestor 204, a request for a modified payment token, the request comprising an account identifier; a step 404 of transmitting an authorisation request to an issuer server 210 associated with the account identifier, the authorisation request comprising a request for either advanced authorisation or pre-authorisation of funds from an account associated with the account identifier; and a step 406 of receiving, from the issuer server 210, an authorisation response indicating whether the authorisation request was successful or declined. If the authorisation request is successful, a step 408 of generating a modified payment token comprising tokenised account details associated with the account identifier and either advanced authorised funds or a pre-authorised fund value; and a step 410 of transmitting, to the token requestor 204, the modified payment token for use in an express payment transaction. If the authorisation request is declined, a step 412 of transmitting a refusal to the token requestor 204.

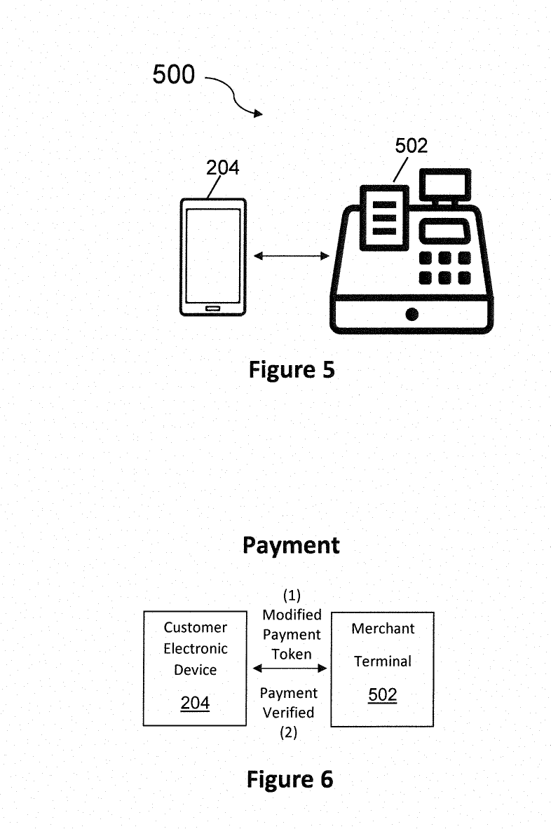

FIG. 5 shows a payment system 500 using the modified payment token generated above for an express payment transaction, in accordance with an embodiment of the invention. The payment system 500 comprises the token requestor 204 (i.e. customer electronic device) in near-field communication (NFC) with a merchant terminal 502 for performing an express payment transaction.

The merchant terminal 502 is configured to receive the modified payment token from an application executed on the customer electronic device (or any other suitable device), for example via Tap & Pay or other contactless payment technology to initiate an express payment transaction.

FIG. 6 shows a payment process flow performed using the payment system 500, in accordance with an embodiment of the invention. Thus, in a first step (1) the customer electronic device 204 is tapped on the merchant terminal 502 and the modified payment token stored in the customer electronic device 204 is transmitted to the merchant terminal 502 to initiate an express payment transaction.

As described above, the modified payment token comprises a token number and one or more of: a transaction limit, a transaction number limit, an accumulative value limit and a token use limit associated with the advanced authorised funds or pre-authorised funds associated with the modified payment token. The customer electronic device 204 also generates a cryptogram that is transmitted with the token.

Once the merchant terminal 502 receives the modified payment token it performs a basic local check to verify whether the modified payment token is valid or not. This may comprise checking whether one or more of the following conditions are satisfied: i) the modified payment token has not expired; ii) the modified payment token contains all required data; iii) the advanced authorised funds or pre-authorised fund value is sufficient for the express payment transaction. The merchant terminal may also determine whether the advanced authorised funds or pre-authorised fund value is less than or equal to a predetermined limit for express payment transactions. The entire verification may take about 0.5 to 1 second thereby greatly increasing the speed of a tokenised payment transaction since no remote authorisation is required in real-time.

Once verified, the express payment transaction is approved in a step (2) and the customer may receive his/her purchased goods/services.

If the merchant terminal 502 determines that a condition is not met and the modified payment token is not verified, the express payment transaction is refused.

In the case of pre-authorised funds, the pre-authorised fund value is placed into an authorisation file for actual authorisation of the funds (i.e. deduction from the account) at a predefined time (e.g. at an end of a day). In this case, a normal (delayed) authorisation process may be carried out via an acquirer server, payment network and issuer server, as described in more detail below in relation to FIG. 8. However, no such authorisation step is required for the advanced authorised funds.

In both cases, the advanced authorised funds (or the pre-authorised fund value once authorised) are placed into a clearing file for clearing and settlement at a predefined time (e.g. at an end of a day). Thus, as normal, after the transaction is complete, the funds will later be transferred from the holding account at the issuer server 210 to a merchant account associated with the merchant terminal 502.

If there are funds remaining in the modified payment token at the end of a predefined period (e.g. each day), the customer may choose to refund the remaining funds back to his/her account or to re-allocate them into a modified payment token for the next period (i.e. the next day). In this case, the customer may instruct the customer electronic device 204 (e.g. via an application) to communicate with the issuer server 210 (optionally via a token requester server 206 and/or tokenisation platform 208) to refund or re-allocate the remaining funds at the end of the period.

In some embodiments, if the advanced authorised funds or pre-authorised fund value is greater than a transaction value, the merchant terminal 502 may receive a full amount of the advanced authorised funds or pre-authorised fund value and may subsequently refund the customer with an amount equal to the overpayment.

In some embodiments, the merchant terminal 502 may deduct only a transaction value from the advanced authorised funds or pre-authorised fund value, leaving the remaining funds in the modified payment token for later use. This can be achieved, for example, through notification services provided by the tokenisation platform. The merchant terminal may send an authorisation request with a new identifier to identify this type of transaction and the tokenisation platform may trigger a notification service to both the issuer server and the customer electronic device so that the issuer server knows the transaction value spent at the merchant terminal and the value of the advanced authorised funds or pre-authorised fund value in the modified payment token can be updated accordingly.

Once the number of express payment transactions permitted using a single modified payment token (i.e. the token use limit) is reached, the customer may be asked (e.g. via the token requestor 204) to request a new modified payment token in order to replenish the advanced authorised funds or pre-authorised fund value by transferring or reserving more funds from the account.

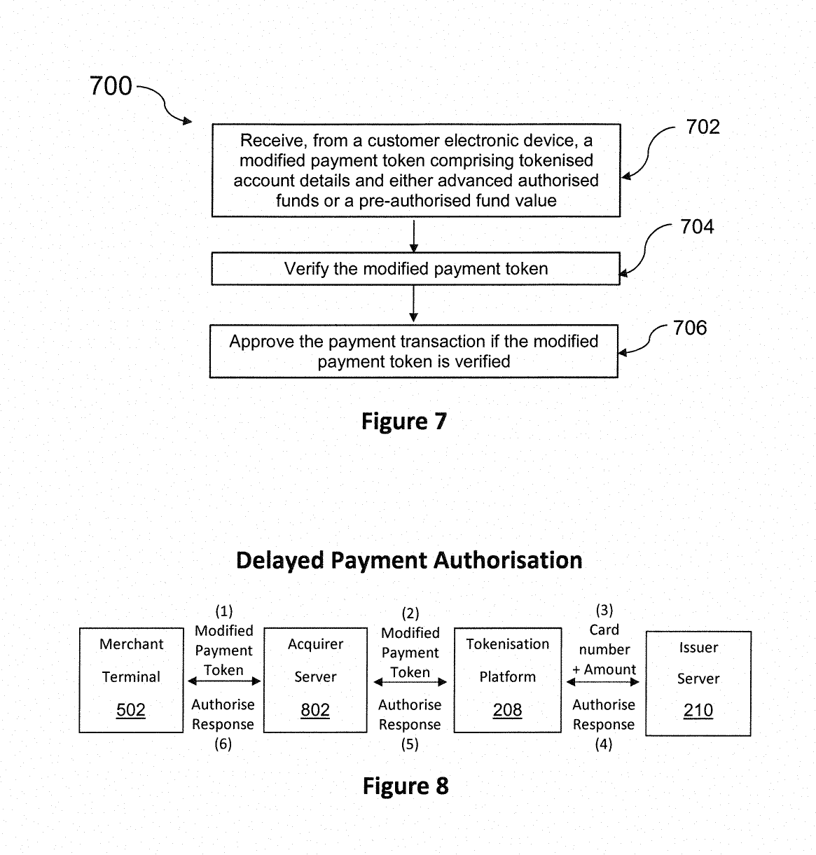

FIG. 7 illustrates the main steps of a method 700 for processing an express payment transaction at a merchant terminal 502, in accordance with an embodiment of the invention. The method 700 comprises: a step 702 of receiving, from a customer electronic device 204, a modified payment token comprising tokenised account details and either advanced authorised funds or a pre-authorised fund value; a step 704 of verifying the modified payment token; and a step 706 of approving the payment transaction if the modified payment token is verified.

FIG. 8 shows a delayed payment authorisation flow in accordance with some embodiments of the invention, whereby a pre-authorised fund value is included in the modified payment token. It should be noted that this authorisation flow is similar to the conventional authorisation flow of FIG. 1B albeit, in this instance, the authorised is delayed so as to not increase the waiting time of a customer during an express payment transaction.

The merchant terminal 502 initiates the delayed authorisation by transmitting the modified payment token to an acquirer server 802, in a first step (1). In a step (2) the acquirer server 802 transmits the modified payment token to a payment network server which includes the tokenisation platform 208. The tokenisation platform 208 decrypts the modified payment token back into the card number and transmits the card number along with the transaction amount (which is also relayed with the modified payment token from the merchant terminal 502) to the issuer server 210, in a step (3). The issuer server 210 verifies the card number and amount and authorises the transaction if there are sufficient funds in an account associated with the card number. In a step (4), the issuer server 210 transmits an authorisation response to the tokenisation platform 208 to confirm whether the transaction is approved or denied. The tokenisation platform 208 transmits the authorisation response to the acquirer server 802 in a step (5) and, in turn, the acquirer server 802 transmits the authorisation response to the merchant terminal 502 in a step (6).

Embodiments of the invention therefore provide a technology infrastructure which enables secure and express payment transactions with reduced transaction times by using modified payment tokens. For example, in some situations, an express payment transaction can take between 0.5 and 1 second to complete.

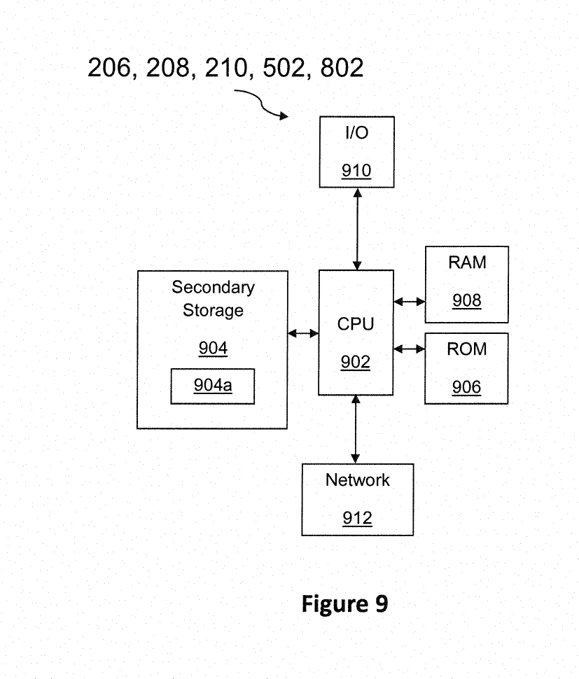

FIG. 9 is a block diagram showing a technical architecture of the token requestor server 206, tokenisation platform 208, issuer server 210, merchant terminal 502 and acquirer server 802.

The technical architecture includes a processor 902 (which may be referred to as a central processor unit or CPU) that is in communication with memory devices including secondary storage 904 (such as disk drives), read only memory (ROM) 906, and random access memory (RAM) 908. The processor 902 may be implemented as one or more CPU chips. The technical architecture may further comprise input/output (I/O) devices 910, and network connectivity devices 912.

The secondary storage 904 is typically comprised of one or more disk drives or tape drives and is used for non-volatile storage of data and as an over-flow data storage device if RAM 908 is not large enough to hold all working data. Secondary storage 904 may be used to store programs which are loaded into RAM 908 when such programs are selected for execution.

In some embodiment, the secondary storage 904 has a processing component 904a comprising non-transitory instructions operative by the processor 902 to perform various operations of the method of the present disclosure. For example, in the tokenisation platform 208, the processing component 904a will store instructions for carrying out the method of FIG. 4 and in the merchant terminal 502, the processing component 904a will store instructions for carrying out the method of FIG. 7.

The ROM 906 is used to store instructions and perhaps data which are read during program execution. The secondary storage 904, the RAM 908, and/or the ROM 906 may be referred to in some contexts as computer readable storage media and/or non-transitory computer readable media.

I/O devices 910 may include printers, video monitors, liquid crystal displays (LCDs), plasma displays, touch screen displays, keyboards, keypads, switches, dials, mice, track balls, voice recognizers, card readers, paper tape readers, or other input devices. In the merchant terminal 502, the I/O devices 910 may comprise, amongst other components, a near-field communication (NFC) transceiver for receiving NFC signals from customer electronic devices 204.

The network connectivity devices 912 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other network devices. These network connectivity devices 912 may enable the processor 902 to communicate with the Internet or one or more intranets. With such a network connection, it is contemplated that the processor 902 might receive information from the network, or might output information to the network in the course of performing the above-described method operations. Such information, which is often represented as a sequence of instructions to be executed using processor 902, may be received from and outputted to the network, for example, in the form of a computer data signal embodied in a carrier wave. For example, in the tokenisation platform 208, the network connectivity devices 912 will facilitate communication between the token requestor server 206 and issuer server 210. In the merchant terminal 502, the network connectivity devices 912 may facilitate communication with the merchant server and acquirer server 802.

The processor 902 executes instructions, codes, computer programs, scripts which it accesses from hard disk, floppy disk, optical disk (these various disk based systems may all be considered secondary storage 904), flash drive, ROM 906, RAM 908, or the network connectivity devices 912. While only one processor 902 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing an application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 902, the RAM 908, and the ROM 906 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

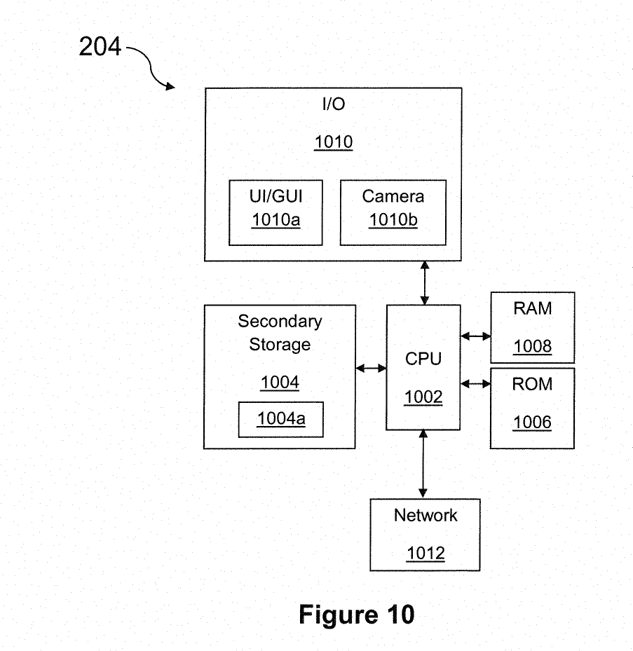

FIG. 10 is a block diagram showing a technical architecture of a communication device (e.g. the customer electronic device 204). The technical architecture includes a processor 1002 (which may be referred to as a central processor unit or CPU) that is in communication with memory devices including secondary storage 1004 (such as disk drives or memory cards), read only memory (ROM) 1006, and random access memory (RAM) 1008. The processor 1002 may be implemented as one or more CPU chips. The technical architecture further comprises input/output (I/O) devices 1010, and network connectivity devices 1012.

The I/O devices 1010 comprise a customer interface (UI) 1010a and a camera 1010b. The UI 1010a may comprise a screen in the form of a touch screen, a keyboard, a keypad or other known input device. The camera 1010b is a device for recording visual images in the form of photographs, film or video signals. The UI 1010a may be configured to operate with the processor 1002 together with the memory devices 1004, 1006, 1008 in conjunction with the network connectivity devices 1012 to request a modified payment token and to use the modified payment token in an express payment transaction. The account identifier may be input via the UI 1010a.

The secondary storage 1004 is typically comprised of a memory card or other storage device and is used for non-volatile storage of data and as an over-flow data storage device if RAM 1008 is not large enough to hold all working data. Secondary storage 1004 may be used to store programs which are loaded into RAM 1008 when such programs are selected for execution.

In this embodiment, the secondary storage 1004 has a processing component 1004a, comprising non-transitory instructions operative by the processor 1002 to perform various operations of the method of the present disclosure. The ROM 1006 is used to store instructions and perhaps data which are read during program execution. The secondary storage 1004, the RAM 1008, and/or the ROM 1006 may be referred to in some contexts as computer readable storage media and/or non-transitory computer readable media.

The network connectivity devices 1012 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other network devices. These network connectivity devices 1012 may enable the processor 1002 to communicate with the Internet or one or more intranets. With such a network connection, it is contemplated that the processor 1002 might receive information from the network, or might output information to the network in the course of performing the above-described method operations. Such information, which is often represented as a sequence of instructions to be executed using processor 1002, may be received from and outputted to the network, for example, in the form of a computer data signal embodied in a carrier wave. In embodiments, the network connectivity devices 1012 enable the customer electronic device 204 to communicatively connect to the token requestor server 206. The network connectivity devices 1012 may also enable the customer electronic device 204 to be in communication with the merchant terminal 502 and the issuer server 210.

The processor 1002 executes instructions, codes, computer programs, scripts which it accesses from hard disk, floppy disk, optical disk (these various disk based systems may all be considered secondary storage 1004), flash drive, ROM 1006, RAM 1008, or the network connectivity devices 1012. While only one processor 1002 is shown, multiple processors may be present. Thus, while instructions may be discussed as executed by a processor, the instructions may be executed simultaneously, serially, or otherwise executed by one or multiple processors. In an embodiment, if an application compatible with the tokenisation and/or payment process is used, the processor 1002 is configured to execute the application stored in the ROM 1006 and/or RAM 1008 or the secondary storage 1004 for generation or use of a modified payment token, as described in the exemplary embodiments.

Whilst the foregoing description has described exemplary embodiments, it will be understood by those skilled in the art that many variations of the embodiments can be made within the scope of the present invention as defined by the claims. Moreover, features of one or more embodiments may be mixed and matched with features of one or more other embodiments.

1. A tokenisation platform for generating a modified payment token for an express payment transaction, the tokenisation platform comprising at least a computer processor and a data storage device, the data storage device comprising instructions operative by the processor to:
receive, from a token requestor, a request for a modified payment token, the request comprising an account identifier;
transmit an authorisation request to an issuer server associated with the account identifier, the authorisation request comprising a request for advanced authorisation or pre-authorisation of funds from an account associated with the account identifier;
receive, from the issuer server, an authorisation response indicating whether the authorisation request was successful or declined;
if the authorisation request is successful;
generate a modified payment token comprising tokenised account details associated with the account identifier and either advanced authorised funds or a pre-authorised fund value; and
transmit, to the token requestor, the modified payment token for use in an express payment transaction.

2. The tokenisation platform according to claim 1 wherein the token requester is constituted by an application executed on a customer electronic device.

3. The tokenisation platform according to claim 1, wherein the account identifier is a card number, a primary account number (PAN), an account name, a mobile phone number or a customer identification (ID).

4. The tokenisation platform according to claim 1, wherein the account details comprise one or more of: a card number, a primary account number (PAN), an account name, an expiry date and a card verification value (CVV).

5. The tokenisation platform according to claim 1, wherein the request for a modified payment token further comprises one or more of the following parameters: a maximum value for each express payment transaction; a maximum number of express payment transactions permitted in a predefined period; a maximum value of express payment transactions permitted in a predefined period; and a maximum number of express payment transactions permitted using a single modified payment token.

6. The tokenisation platform according to claim 5 wherein the request for advanced authorisation or pre-authorisation of funds comprises the parameters in the request for a modified payment token.

7. A merchant terminal for processing an express payment transaction comprises at least a computer processor and a data storage device, the data storage device comprising instructions operative by the processor to:
receive, from a customer electronic device, a modified payment token comprising tokenised account details and either advanced authorised funds or a pre-authorised fund value;
verify the modified payment token; and
approve the express payment transaction if the modified payment token is verified.

8. The merchant terminal according to claim 7 wherein the customer electronic device is a mobile device running an application using near-filed communication (NFC) technology to initiate the express payment transaction.

9. The merchant terminal according to claim 7 wherein the step of verifying the modified payment token comprises checking whether one or more of the following conditions are satisfied: i) the modified payment token has not expired; ii) the modified payment token contains all required data; iii) the advanced authorised funds or pre-authorised fund value is sufficient for the express payment transaction.

10. The merchant terminal according to claim 7 wherein the data storage device comprises further instructions operative by the processor to determine whether the advanced authorised funds or pre-authorised fund value is less than or equal to a predetermined limit for express payment transactions.

11. The merchant terminal according to claim 9 wherein the data storage device comprises further instructions operative by the processor to refuse the express payment transaction if the merchant terminal determines that any one condition is not met and the modified payment token is not verified.

12. The merchant terminal according to claim 7 wherein the data storage device comprises further instructions operative by the processor to place the pre-authorised fund value into an authorisation file for actual authorisation of the funds in a later authorisation process.

13. The merchant terminal according to claim 7 wherein the data storage device comprises further instructions operative by the processor to place the advanced authorised funds, or pre-authorised fund value once authorised, into a clearing file for clearing and settlement at a predefined time.

14. The merchant terminal according to claim 7 wherein the data storage device comprises further instructions operative by the processor to determine if the advanced authorised funds or pre-authorised fund value is greater than a transaction value, and to initiate a refund procedure to refund an amount equal to the advanced authorised funds or pre-authorised fund value minus the transaction value.

15. The merchant terminal according to claim 7 wherein the data storage device comprises further instructions operative by the processor to deduct only a transaction value from the advanced authorised funds or pre-authorised fund value, leaving remaining funds in the modified payment token for later use.

16. A computer-implemented method for generating a modified payment token for an express payment transaction comprising:
receiving, from a token requestor, a request for a modified payment token, the request comprising an account identifier;
transmitting an authorisation request to an issuer server associated with the account identifier, the authorisation request comprising a request for either advanced authorisation or pre-authorisation of funds from an account associated with the account identifier;
receiving, from the issuer server, an authorisation response indicating whether the authorisation request was successful or declined;
if the authorisation request is successful;
generating a modified payment token comprising tokenised account details associated with the account identifier and either advanced authorised funds or a pre-authorised fund value; and
transmitting, to the token requestor, the modified payment token for use in an express payment transaction.
